(19) United States
(12) Patent Application Publication
(10) Pub. No.: US 2015/0230301 A1
(43) Pub. Date: Aug. 13, 2015

(54) ELECTRONIC POWER DEVICE FOR A LIGHT EMITTING DIODE

(71) Applicant: EM Micorelectronic-Martin SA, Marin (CH)

(72) Inventors: Jérôme Saby, Neuchatel (CH); Yves Theoduloz, Yverdon (CH); Cyril Marti, Lignieres (CH)

(21) Appl. No.: 14/615,093

(22) Filed: Feb. 5, 2015

(30) Foreign Application Priority Data
Feb. 13, 2014 (EP) 14154986.5

(51) Int. Cl. H05B 33/08

(52) U.S. Cl. CPC H05B 33/0815

(57) ABSTRACT

The electronic device arranged to periodically power a light emitting diode is intended to be arranged between the light emitting diode and a battery forming an electrical power source, and includes a boost type voltage converter and an electrical energy storage capacitor, arranged downstream of the voltage converter parallel to the diode, a current source and a switch controlled by a control unit of the electronic device. The current source and the switch are arranged in series between said storage capacitor and a lower voltage terminal on the electrical path provided for powering the light emitting diode. The current source is arranged to impose, when actuated, a constant current corresponding to the operating current provided for the diode.

This application claims priority from European Patent Application No. 14154986.5 filed Feb. 13, 2014, the entire disclosure of which is incorporated herein by reference.

### FIELD OF THE INVENTION

The present invention concerns the field of electronic power devices for light emitting diodes with a battery as the electrical energy source. In particular, the invention concerns the case where the battery is of small dimensions and inexpensive, for example a small battery of small thickness which is generally arranged to deliver a low instantaneous current.

### BACKGROUND OF THE INVENTION

FIG. 1 shows a schematic view of a prior art electronic device for powering a light emitting diode, hereafter also referred to as an “LED”. This electronic system 2 includes a battery 4 and a light emitting diode 6. Battery 4 has a no-load voltage V_{Bat} and a relatively high internal resistance R_{B}. In particular, for a supply current I ᵢₙ substantially equal to a given operating current of the LED 6, the battery provided delivers a supply voltage Vᵢₙ across its external terminals which is lower than the corresponding LED operating current. Thus, the electronic system further includes an electronic device formed of a boost-type voltage converter 8 arranged between an external terminal of the battery and LED 6. This voltage converter has a multiplier factor K in steady-state operation and a yield η. The converter is arranged to boost the voltage Vₛᵤₚ supplied to the LED so that this voltage is at least equal to the LED operating voltage. Given that the power supplied by the converter to the LED is equal to Pₛᵤₚ=η·Pᵢₙ=n·Vᵢₙ Iᵢₙ, the current supplied to the LED is equal to Iₛᵤₚ=η·Iᵢₙ/K.

In a first variant, electronic system 2 continuously powers the LED. In a second variant, the LED is periodically powered. This latter case is often implemented since it enables electrical power consumption to be reduced and the periodic light signal provides sufficient or better visual information.

For electronic system 2 to be functional, the battery must be chosen to enable electronic device 8 and the LED to be powered directly. Thus, the battery must have limited internal resistance. Indeed, for electronic system 2 to operate, there must first be a voltage Vᵢₙ, higher than or equal to the minimum LED voltage V_{LED}^{min} divided by the multiplier factor K (Vᵢₙ>=V_{LED}^{min}/K), so that the battery power P_{Bat}(Vᵢₙ) is higher than or equal to the minimum LED operating power P_{LED}^{min} multiplied by the yield η of electronic device 8, namely P_{Bat}(Vᵢₙ)>=η·P_{LED}^{min}. Further, voltage Vᵢₙ which satisfies this first condition must be higher than or equal to the minimum operating voltage Vᵢₙ^{min} of electronic device 8 which includes the voltage converter and its electronic control unit.

A maximum value for internal resistance R_{B}, beyond which it is not theoretically possible for the electronic system to be functional, can be deduced from the preceding considerations regarding the operating conditions of electronic system 2. Since the maximum power Pᵢₙ^{max} that the battery can provide is given by the relation Pᵢₙ^{max}=V_{Bat}²/4R_{B}, the electronic system is not functional if the internal resistance R_{B}>(η/4)·(V_{Bat})²/P_{LED}^{min}. Further, if voltage Vᵢₙ^{min} is higher than half of voltage V_{Bat}, this system is no longer functional once R_{B}>η·(V_{Bat}−Vᵢₙ^{min})·Vᵢₙ^{min}/P_{LED}^{min}. Let us consider an example for a specific application: To operate properly the LED requires a voltage V_{LED}=Vₛᵤₚ=3.0 V and an electric current I_{LED}=Iₛᵤₚ=1.0 mA, the selected battery has a no-load voltage_{Bat}=1.5 V and the voltage converter is a voltage tripler with a minimum operating voltage Vᵢₙ^{min}=0.9 V and a yield of 80%. For this application to be functional, internal resistance R_{B} must therefore be lower than or equal to R_{B}^{max}=144Ω. With regulation at Vᵢₙ=1.0 V and if R_{B}=125Ω, a supply current Iₛᵤₚ of around 1.07 mA is obtained with no other losses; which is suitable for the continuous mode or periodic mode application. However, if there is a resistance R_{B}=140Ω for this regulated voltage, the current Iₛᵤₚ has a value of approximately 0.95 mA; which is lower than the 1.0 mA required.

The small inexpensive batteries are generally characterized by a relatively high internal resistance, for example between 200Ω and 400Ω. Indeed, in principle, the decrease in internal resistance results in an increase in the cost and/or size of the battery. Moreover, some commercially advantageous technologies are not possible at a lower cost if the internal resistance of the battery has to be limited, for example for flat and flexible batteries. There is therefore a need for an electronic power device for an LED which could have, as energy source, a battery with a relatively high internal resistance, in particular higher than the maximum theoretical value given above.

### SUMMARY OF THE INVENTION

It is an object of the present invention to find a solution to the aforementioned problem, in order to be able to properly power a light emitting diode with a battery whose internal resistance is high.

To this end, the present invention concerns an electronic device for powering an LED as defined in claim 1.

As a result of the features of the present invention, it is possible to periodically power an LED, in particular with a higher power than the maximum power that the selected battery can deliver, while controlling the electrical current that flows through the LED so as to optimise the dimensions of the various electronic elements and electrical power consumption. The storage capacitor makes it possible to decouple the electrical power supplied by the battery and the electrical power supplied to the LED. It is therefore possible to optimise operating conditions, on the one hand, for the part of the electronic system formed by the selected battery, the voltage converter and the control unit, and, on the other hand, for the part of the electronic system formed by the LED and the current source.

### BRIEF DESCRIPTION OF THE DRAWINGS

The invention will be described below with reference to the annexed drawings, given by way of non-limiting example, and in which:

FIG. 1, described above, shows a schematic view of an autonomous prior art electronic system with an LED;

FIG. 2 is a schematic view of an autonomous electronic system with a periodically powered LED and an electronic device according to the invention for powering the diode; and

FIG. 3 shows graphs, as a function of time, of the voltage across the storage capacitor terminals, of the voltage across the current source terminals and of the diode supply current for a specific arrangement of the electronic system of FIG. 2.

### DETAILED DESCRIPTION OF THE INVENTION

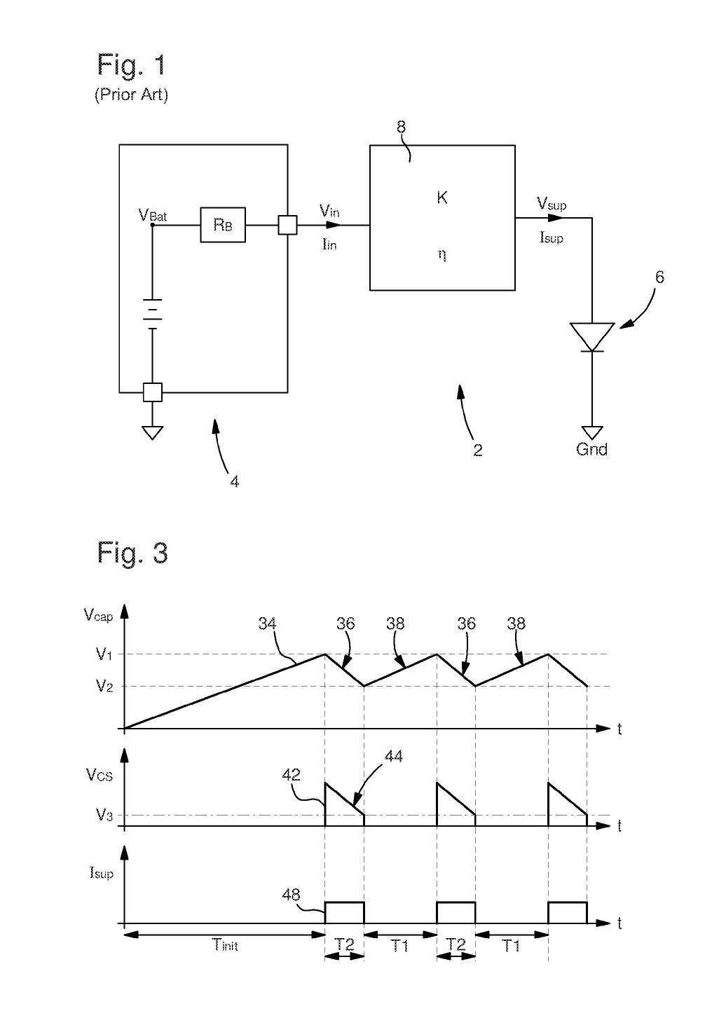

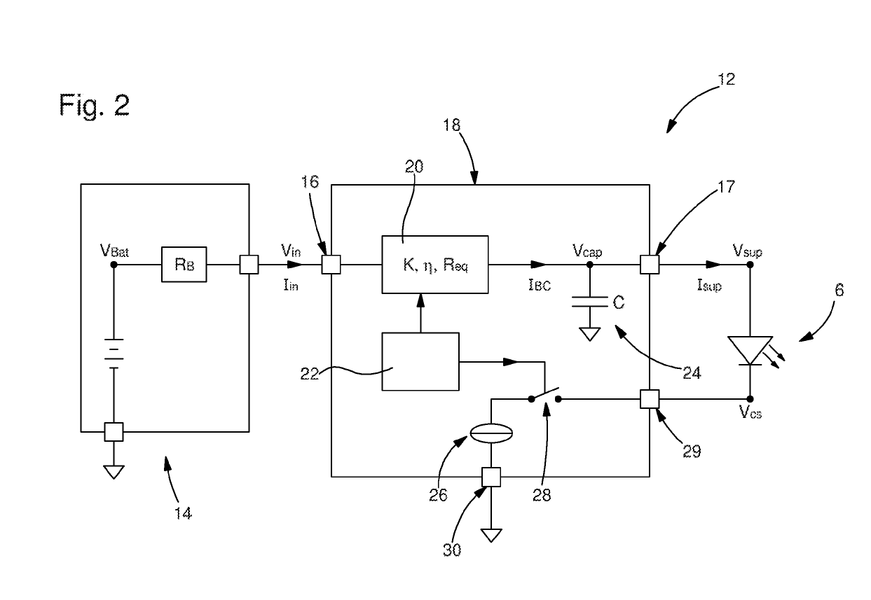

With reference to FIGS. 2 and 3, there will be described below an embodiment of an electronic device for powering a light emitting diode according to the invention. Electronic device 18 is intended to be arranged between a light emitting diode 6 and a battery 14 forming an electrical power source. The battery has a no-load voltage V_{Bat} and an internal resistance R_{B}. This electronic device 18, LED 6 and battery 14 together form an autonomous electronic system 12. Within the scope of the invention, the battery supplies a supply voltage Vᵢₙ, for a supply current Iᵢₙ equal to a given operating current of the light emitting diode, which is lower than the corresponding operating voltage of the light emitting diode. Thus, as in the FIG. 1 embodiment, the electronic device includes a boost converter 20 which is arranged between an input pad 16 intended to be connected to battery 14 and an output pad 17 intended to be connected to a first terminal of LED 6. This converter is characterized by a multiplier factor K, a yield η in steady-state phase and an equivalent internal resistance R_{eq}. According to a main embodiment variant, the battery provided has an internal resistance R_{B} which is higher than (η/4)·(V_{Bat})²/P_{LED}^{min}, η being the yield of the electronic device with the voltage converter in steady state and P_{LED}^{min} the minimum LED actuation power.

Electronic device 18 further includes an electrical energy storage capacitor 24, arranged downstream of the voltage converter parallel to output pad 17, a current source 26 and a switch 28 controlled by a control unit 22 of the electronic device. Generally, the current source and the switch are arranged in series between storage capacitor 24 and a lower voltage terminal 30 on the electrical path provided for powering the LED. In the variant shown in FIG. 2, the current source and the switch are arranged between the lower voltage terminal 30 and a contact pad 29 connected to the second LED terminal. The current source is arranged to impose, when actuated, i.e. when the switch is closed and thus conductive, a constant current I_{CS} which corresponds to the operating current Iₛᵤₚsupplied to the LED by the electronic device.

According to the invention, storage capacitor charging phases and LED actuation phases are provided alternately. To achieve this, control unit 22 is arranged to control switch 28 so as to make it alternately non-conductive during first periods T1 and conductive during second periods T2. In FIG. 3, curve 34 gives the storage capacitor voltage V_{cap} over time. After an initialisation period Tᵢₙᵢₜ, the LED is powered during periods T2 (actuation phases) where V_{cap} gradually decreases between a higher voltage V1 and a lower voltage V2 (segments 36), and it is deactivated during periods T1 (charging phases) where voltage V_{cap} gradually rises between V2 and V1 (segments 38) due to the charging of the storage capacitor by the battery.

### LED Actuation Phases

During an LED actuation phase it is important that the supply voltage Vₛᵤₚ supplied by the electronic device to the diode remains higher than or equal to a minimum voltage Vₛᵤₚ^{min} corresponding to the sum of the LED operating voltage V_{LED} and a minimum current source actuation voltage V_{CS}^{min}. The supply voltage is equal to the voltage supplied by the storage capacitor V_{cap} in this embodiment, and therefore V_{cap}=Vₛᵤₚ>=V_{LED}+V_{CS}^{min} throughout the actuation phase and particularly for supply voltage V2 at the end of this actuation phase. Since voltage V_{LED} is constant with a constant supply voltage Iₛᵤₚ=I_{CS} (curve 48 in FIG. 3), the voltage V_{CS} (curve 42 in FIG. 3) between contact pad 29 and the lower voltage terminal 30 decreases during the actuation phases (segments 44) to a voltage V3 which is higher than or equal to V_{CS}^{min}.

For the actuation phase, there are two variants depending on whether or not voltage converter 20 remains active during this actuation phase. In the first variant where the voltage converter is inactive, there is the following mathematical relation:

ΔV=V1−V2=I_{CS}·T2/C (1)

where V1 is the supply voltage at the start of the actuation phase, T2 the duration of this actuation phase and C the storage capacitance value.

It will be noted that multiplier coefficient K is preferably provided so that voltage V1 is lower than or equal to K·Vᵢₙ, with Vᵢₙ higher than voltage Vᵢₙ^{min} for the operation of electronic device 18 and corresponding to a given input current Iᵢₙ regulated by the electronic device. In all cases, voltage V1 is lower than the non-load voltage V_{Bat} of the battery multiplied by K. In the second variant, converter 20 is active and the battery directly supplies part of the LED supply current. Therefore:

ΔV=V1−V2=(I_{CS}−I_{BC})·T2/C (2)

Where I_{BC} is the mean current supplied by the voltage converter during period T2.

The mathematical relation (1) or (2) above therefore connects various parameters of the electronic system. If period T2 and current I_{CS} are given (and also I_{BC} determined in the second variant), there is obtained a relation between ΔV and C, namely ΔV·C equal to a determined constant value Q. If V2 is equal to Vₛᵤₚ^{min}, to be able to supply current I_{CS} during period T2, there is obtained an equality giving a higher minimum voltage V1^{min} for a given value C, namely: (V1^{min}−Vₛᵤₚ^{min})=Q/C. There is therefore a direct relation between storage capacitance C and the higher minimum voltage V1^{min}. On the other hand, for a determined higher voltage V1, there is obtained from the aforementioned relation a minimum capacitance value C^{min}: C^{min}=Q/(V1−Vₛᵤₚ^{min}). If value C is selected to be higher than C^{min} in this latter case or if the value of V1 is selected to be higher than V1^{min} in the other case, then the value of V2 at the end of the actuation period is higher than Vₛᵤₚ^{min}.

Taking, for example, an LED as described with reference to FIG. 1, then V_{LED}=3.0 V and there is used a current source which imposes a current I_{CS}=1.0 mA. Next, if, for example, a period T2=100 ms is required and an initial voltage V1=5.0 V is chosen, there is obtained for the first variant: C^{min}≈55 μF with a voltage Vₛᵤₚ^{min}=3.2 V.

### Storage Capacitor Charging Phase

In a storage capacitor charging phase during which the LED is deactivated (switch 28 open and thus non-conductive), the energy conservation law can be used to determine the charging duration T1 and vice versa. To simplify the calculation, the preferred variant will be considered where firstly, the current Iᵢₙ at the input of electronic device 18 is regulated by control unit 22 to be substantially constant provided the voltage W_{cap} across the terminals of capacitor 24 is lower than or equal to the corresponding input voltage Vᵢₙ multiplied by multiplier factor K of the voltage converter, and where secondly, the higher voltage V1 is provided to be lower than or equal to K·Vᵢₙ. It will be noted that voltage Vᵢₙ is provided to be higher than the minimum operating voltage Vᵢₙ^{min} of electronic device 18.

The increase in energy in storage capacitor 24 is given by ΔE=C·(V1²−V2²)/2. This difference in energy is supplied by the battery via the voltage converter, the latter being in a transition phase since the initial voltage V2 is generally lower than K·Vᵢₙ. During period T1, a mean yield η* of the electronic device can be defined, which is generally lower than yield η in steady state phase. Within the scope of the aforementioned preferred variant, the energy provided to the capacitor is defined by ΔE=η*·Vᵢₙ·Iᵢₙ·T1. The following mathematical relation is thus obtained:

C=2η*·Vᵢₙ·Iᵢₙ·T1/(V1²−V2²) (3)

Utilising the values of the example considered for the actuation phase and a yield of η*=0.6 (60%), a voltage Vᵢₙ=1.0 V and the battery used in the preceding numerical examples (V_{Bat}=1.5 V and R_{B}=300Ω), there is obtained a current Iᵢₙ=1.66 mA. Next, with a period T1^{max}=900 ms, there is obtained from mathematical relation (3) a maximum storage capacitance value C^{max}=˜120 μF.

In the given numerical example, it is thus noted that, with T1=100 ms and T2=900 ms, namely T1+T2=1.0 s (one second), the storage capacitance value may be comprised between two end values defined, on the one hand, by the actuation phase and on the other hand, by the charging phase: 55 μF<C<120 μF. There is thus a certain freedom in the choice of storage capacitor according to the desired application. Thus, to decrease the duration of charging period T1, C will be set lower than but close to 120 μF. However, if it is desired to reduce energy consumption and thus to increase the longevity of the battery, C will be set higher than but close to 55 μF to reduce the energy dissipated by the battery. With, for example C=60 μF, the input power necessary is Pᵢₙ=0.82 mW. The input voltage, corresponding to the voltage delivered by the battery, thus has a value Vᵢₙ≈1.3 V and the corresponding current Iᵢₙ=0.63 mA. The electronic device can therefore be arranged so that the current drawn from the battery is regulated at Iᵢₙ=0.65 mA or, taking account of residual losses not included in the calculations, for example Iᵢₙ=0.70 mA. It will be noted that with Vᵢₙ=1.25 V, the voltage converter can have a multiplier factor K=4, instead of K=5 where Vᵢₙ=1.0 V. On the other hand, it is also possible to select a higher capacitance C, for example C 150 μF, and to reduce the selected higher voltage V1, particularly to V1=3.9 V. In this latter case, it is then possible to further decrease the multiplier factor and to choose a voltage tripler.

Thus, according to the invention, storage capacitance value C, higher voltage V1 and the first and second periods T1 and T2, for a given LED and battery and for the elements of the electronic device other than the storage capacitor, are selected so that, on the one hand, the voltage across the storage capacitor terminals in each actuation period remains higher than or equal to a minimum supply voltage Vₛᵤₚ^{min}, equal to the sum of the LED operating voltage V_{LED} and a minimum current source actuation voltage V_{CS}^{min}, and so that, on the other hand, the voltage at the storage capacitor terminals at the end of each charging period is at least equal to higher voltage V1. The voltage converter is selected with a multiplier factor which allows at least this higher voltage to be achieved at the storage capacitor terminals for the battery provided.

Finally, as previously indicated, according to a preferred variant of the electronic device, control unit 22 is arranged to regulate the supply current Iᵢₙ supplied by the battery to the electronic device so that the supply voltage Vᵢₙ of the battery remains higher than a minimum supply voltage Vᵢₙ^{min} of the electronic device.

What is claimed is:

1. An electronic device for powering a light emitting diode and intended to be arranged between said light emitting diode and a battery forming an electrical power source, said electronic device including a boost type voltage converter arranged between an input terminal intended to be connected to the battery and an output terminal intended to be connected to the light emitting diode;
wherein the electronic device further includes an electrical energy storage capacitor, arranged downstream of the voltage converter parallel to said output terminal, a current source and a switch controlled by the control unit of said electronic device, said current source and said switch being arranged in series, between said storage capacitor and a lower voltage terminal, on the electrical path provided for powering the light emitting diode; wherein the current source is arranged to impose, when actuated, a substantially constant current corresponding to the operating current provided for the light emitting diode; and wherein the control unit is arranged to control said switch so as to render the switch alternately non-conductive during first periods and conductive during second periods; the value of the storage capacitor, a higher voltage across the terminals of said storage capacitor at the start of each second period and the first and second periods being selected so that, on the one hand, the voltage across the storage capacitor terminals in each second period remains higher than or equal to a minimum supply voltage, equal to the sum of the light emitting diode operating voltage for said operating current and a minimum current source actuation voltage, and so that, on the other hand, the voltage across the storage capacitor terminals at the end of each first period is at least equal to said higher voltage, the voltage converter being selected with a multiplier factor making it possible to attain at least said higher voltage across the storage capacitor terminals for said battery.

2. The electronic device according to claim 1, wherein the control unit is arranged to regulate the supply current supplied by the battery to said electronic device so that the battery supply voltage remains higher than a minimum supply voltage of the electronic device.

3. An autonomous electronic system comprising a diode, a battery and an electronic device according to claim 1 and arranged between the battery and the diode, wherein the battery has an internal resistance which is higher than (η/4)·(V_{Bat})²/P_{LED}^{min}, η being the yield of the electronic device with the voltage converter in steady state and P_{LEDmin} the minimum light emitting diode actuation power.

4. An autonomous electronic system comprising a diode, a battery and an electronic device according to claim 2 and arranged between the battery and the diode, wherein the battery has an internal resistance which is higher than (η/4)·(V_{Bat})²/P_{LED}^{min}, η being the yield of the electronic device with the voltage converter in steady state and P_{LEDmin} the minimum light emitting diode actuation power.
